(19) United States
(12) Patent Application Publication
(10) Pub. No.: US 2024/0210785 A1
(43) Pub. Date: Jun. 27, 2024

(54) THERMAL LASER WITH DYNAMIC BEAM STEERING

(71) Applicant: Wisconsin Alumni Research Foundation, Madison, WI (US)

(72) Inventors: Victor Brar, Madison, WI (US); Joel Siegel, Deerfield, IL (US)

(21) Appl. No.: 18/146,600

(22) Filed: Dec. 27, 2022

(51) Int. Cl. G02F 1/29

(52) U.S. Cl. CPC G02F 1/292; G02F 2202/30; G02F 2202/36; G02F 2203/11; G02F 2203/50

(57) ABSTRACT

Thermal lasers that emit narrowband, coherent infrared (IR), mid-infrared (MIR), or visible radiation with a tunable angle of emission are provided. The lasers include a metasurface that generates a lobe of narrowband, coherent thermal radiation at a desired frequency. The thermal radiation is coupled with an oscillating Fabry-Perot (FP) resonance mode of an FP cavity having an electrostatically or thermally adjustable reflection phase shift at the metasurface. This thermal laser design enables the steering of the lobe of emitted radiation continuously through a range of angles by modulating the phase shift at the metasurface.

### BACKGROUND

The mid infrared (MIR) regime is an important band of light for applications ranging from free-space laser communications to chemical sensing applications. A narrow band source with high-speed directional control of the emitted light is required for these applications. Typically, the beam-steering can be controlled with mechanical devices (such as gimbal-mounted mirrors), optical phased arrays of antenna that can control the relative phase of each element, or more recently, liquid crystal-based geometries. While each technique has its own set of advantages and disadvantages, one limitation common to them all is that they require an external source of light, such as the bulky and expensive quantum cascade laser.

An alternative source of MIR light is one that can be found everywhere: thermal radiation. Any material at a non-zero temperature will, due to the movement of charged particles, emit radiation over a broad range of frequencies. The thermal radiation from a generic material will be incoherent, isotropic, and broadband, making it a seemingly poor choice for narrow band, directional steering applications. However, recent advances in nanoengineering have demonstrated that it is possible to engineer the emissivity of a structured material to create narrowband, anisotropic, or coherent thermal radiation sources. (See, for example, C. W. Hsu, et al., Nature Reviews Materials 1, 16048 (2016): J.-J. Greffet, et al., Nature 416, 61-64 (2002).) Heating the sample is all that is necessary to produce the desired light, thus providing an efficient source of MIR radiation. However, the above examples are static and unable to be dynamically tuned.

Recently, graphene has been considered as a candidate material to be incorporated into thermal engineered devices to enable active control of the thermal emission. (V. W. Brar, et al., Nature Communications 6, 7032 (2015).) Graphene, a two-dimensional lattice of carbon atoms, can undergo significant changes to its optical permittivity in the MIR by changing its charge-carrier density via electronic control. (V. W. Brar, et al., Nano Letters 13, 2541-2547 (2013).) It has been theoretically predicted and experimentally demonstrated that graphene can dynamically tune blackbody emissions: however, no angular tuning at a constant magnitude has been demonstrated. (Brar et al., 2015.)

### SUMMARY

Thermal lasers that emit narrow band, coherent radiation, including infrared (IR), mid-infrared (MIR), and/or visible radiation, with a tunable angle of emission are provided. Methods of using the lasers are also provided.

One embodiment of a thermal laser includes: a back reflector: a metasurface: and a dielectric spacer disposed between the back reflector and the metasurface. The metasurface includes: a layer of a phase shifting medium having an electrically or thermally tunable Fermi level or index of refraction: and a planar array of metal elements in a periodic arrangement on the layer of the phase shifting medium. The laser further includes: electrically conductive contacts configured to apply a voltage across the phase shifting medium or a phase shifting medium heater in thermal communication with the phase shifting medium: and a dielectric spacer heater in thermal communication with the dielectric spacer.

One embodiment of a method for creating a steerable thermal laser beam using a thermal laser of a type described herein includes the steps of: heating the dielectric spacer to generate thermal radiation, wherein said thermal radiation couples to an oscillating Fabry-Perot resonance mode in the dielectric spacer to generate a lobe of coherent radiation at an emission angle: and either applying a voltage across the layer of the phase shifting medium or changing the temperature of the phase shifting medium, thereby changing the emission angle of the lobe of coherent radiation.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A is a schematic diagram of one embodiment of a thermal laser. FIG. 1B shows a detailed schematic of the design parameters of the thermal laser of FIG. 1A. FIG IC shows a cross-section of the thermal laser of FIGS. 1A and 1B. FIG. 1D shows an illustration of the operation of the thermal laser. A thermal dipole in a material emits radiation that couples to a Fabry-Perot resonance that is confined on at least one side by a metasurface. The metasurface has a variable phase of reflection that is controlled by a gap plasmon coupled to an embedded graphene sheet. FIG. 1E shows a Scanning Electron Microscope (SEM) image (top view) of the thermal laser.

FIGS. 2A-2B show experimental emission results for a thermal laser based on a graphene/gold nanoresonator metasurface, as described in the Example. FIG. 2A shows emissivity tunability as a function of applied voltage, emitted thermal radiation from carbon nanotubes, and a black body (BB) reference. FIG. 2B shows the angle dependence of emissivity at a constant applied voltage. All measurements were taken at 250° C., and the black body reference is assumed to have emissivity equal to unity.

FIG. 3 shows experimental tuning of the emission lobes for three applied voltages for the thermal laser of the Example.

FIG. 4A shows calculated values of Om as a function of Fermi level. FIGS. 4B and 4C show the calculated absorption (FIG. 4B) frequency and angular spectra (FIG. 4C) for Fermi levels 0.48 eV and 0.622 eV, which corresponds to 0 V and −560 V, respectively. In the angular absorption spectrum calculation, the operating frequency was fixed as 1498 cm₋₁. The carrier mobility of graphene is assumed to be 300 cm²/V·s.

### DETAILED DESCRIPTION

Thermal lasers that emit narrow band, coherent infrared (IR), including mid-infrared (MIR), and/or visible radiation with a tunable angle of emission are provided. The lasers include a dielectric medium that generates thermal radiation and a metasurface that enables the emission of the thermal radiation in the form of a lobe of narrow band, coherent radiation at a desired frequency and angle. The thermal radiation in the dielectric medium is coupled with an oscillating Fabry-Perot (FP) resonance mode in the dielectric medium, wherein the FP resonance condition can be electrically or thermally adjusted by changing the reflection phase shift at the metasurface. This FP cavity design enables the steering of the lobe of emitted radiation continuously through a range of angles by modulating the phase shift at the metasurface. As a result, the thermal lasers provide an efficient source of tunable and narrow band radiation that can operate without the need for mechanical devices, optical phase arrays of antenna, or liquid crystals.

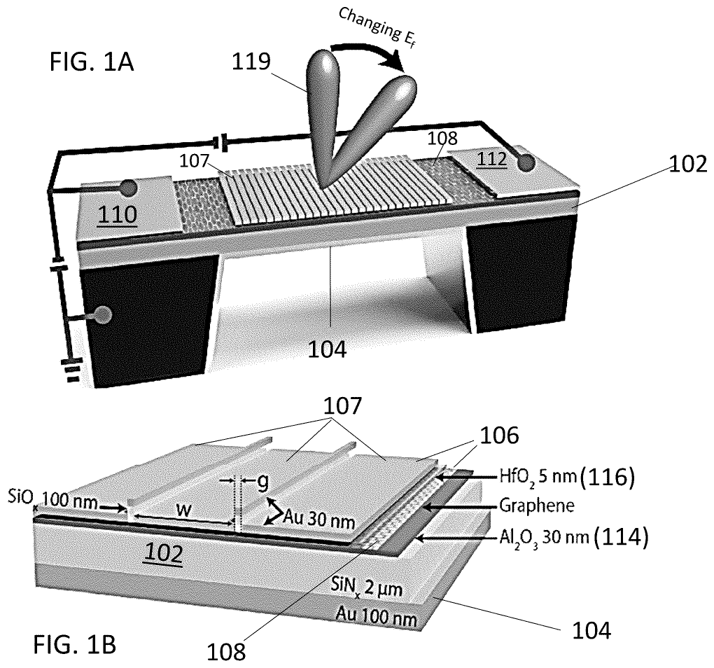

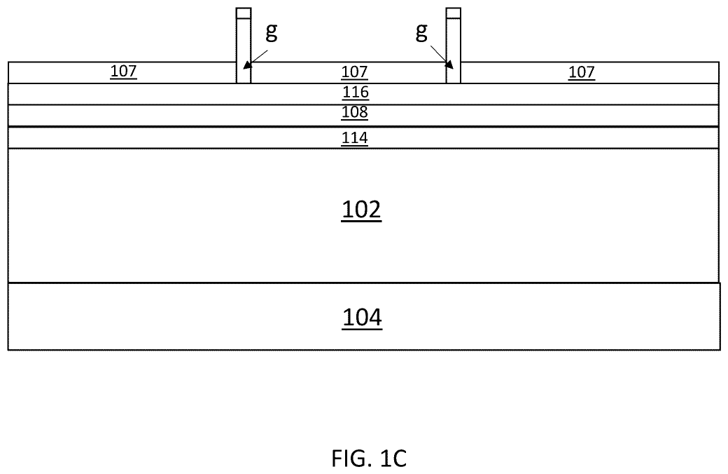

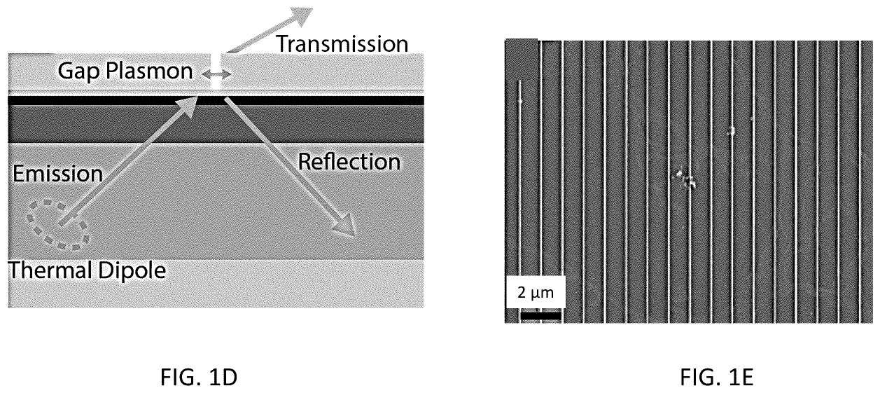

FIGS. 1A-1C are schematic illustrations of an illustrative embodiment of a thermal laser. The laser includes a dielectric spacer 102 sandwiched between a back reflector 104 and an upper metasurface 106 that provides top reflector. Metasurface 106 includes a planar array of metal elements 107 disposed in a periodic arrangement and a thin layer of a phase shifting medium 108 is disposed between metal elements 107 and dielectric spacer 102. Together, metasurface 106, dielectric spacer 102, and back reflector 104 form an FP cavity. Phase shifting medium 108 is characterized in that it has an electrically and/or thermally adjustable Fermi level and/or refractive index that can be modulated to change the phase of radiation reflected at metasurface 106. For purposes of illustration, suitable materials for each layer of the thermal laser are shown in FIGS. 1A and 1B. However, it should be understood that these materials are used only as examples, other materials can be used for each layer in accordance with the operating principles of the device, as described below.

In the embodiment of the thermal laser shown in FIGS. 1A and 1B, phase shifting medium 108 has an electrically adjustable Fermi level. Therefore, the thermal laser in FIGS. 1A and 1B includes electrically conductive contacts 110 and 112 configured to apply a voltage across the phase shifting medium. In the illustrative embodiment of the device shown here, back reflector 104 also serves as a back-gate electrode (i.e., an electrically conductive contact). Embodiments of the device that utilize a phase shifting medium with a thermally adjustable refractive index would include a heat source (not shown), such as a heating element, in thermal communication with phase shifting medium 108 to modulate the temperature of said phase shifting medium. For the purposes of this disclosure, a heat source in thermal communication with the phase shifting medium is referred to as a phase shifting medium heater. The thermal lasers further include a heat source (not shown) in thermal communication with dielectric spacer 102 to heat said dielectric spacer and generate thermal radiation. For the purposes of this disclosure a heat source in thermal communications with the dielectric spacer is referred to as a dielectric spacer heater.

Metal elements 107 of metasurface 106 are nanoresonators that enable constructive interference between thermal dipole radiation that is in-phase with an oscillating FP resonance mode of variable angle supported by the FP cavity. This constructive interference enables directional emission of an angular lobe 119 of narrow band, coherent radiation from the laser. The dimensions and spacing of metal elements 107 determine the emission wavelength of the emitted lobe, while the FP cavity resonance condition determines the emission angle of the emitted lobe. In the laser of FIGS. 1A and 1B, metal elements comprise a grating of parallel metal strips separated by sub wavelength gaps. However, other metal element geometries that produce coherent directional angular radiation emission can be used. Gold is one non-limiting example of a metal that can be used to form metal elements 107.

Based on the principles of operation of the device, which are described in more detail below; the phase shifting medium can be selected from a wide variety of two-dimensions (2D) or three-dimensional (3D) materials, provided that the material can produce an electrically or thermally adjustable reflection phase shift at the metasurface. Graphene is one example of a 2D material having an electrically tunable Fermi level that can be used as a phase shifting medium. Other materials that undergo a change in their Fermi level and/or refractive index in response to a change in applied bias or a change in temperature include, but are not limited to, indium tin oxide (ITO), indium zinc oxide (IZO), titanium nitride, vanadium dioxide (VO₂), germanium-antimony-tellurium (GST), and titanium nitride. Electro-optic polymers, which are organic polymers that change their index of refraction when an external voltage is applied, can also be used. 2D phase shifting media may comprising a single sheet of the 2D material, such as a monolayer of graphene. However, multiple sheets of the 2D materials can also be used.

Dielectric spacer 102 acts as a thermal emitter and can be comprised of a variety of dielectric materials since, according to Planck's law, all objects at non-zero temperatures will emit thermal radiation across the electromagnetic spectrum, with the exact wavelengths and strength dependent on the temperature of the object. Silicon nitride, aluminum oxide, and diamond are a few, non-limiting, examples of dielectric materials that can be used. The temperature to which the dielectric material is heated will depend on the material and the intended application for the thermal laser. Generally, the spacer will be heated to a temperature greater than room temperature (e.g., greater than 25° C.) and, more typically, a temperature of at least 200° C. By way of illustration only, temperatures in the range from about 250° C. to about 500° C. are generally suitable. However, temperatures outside of this range can be used.

For device simplicity, the dielectric spacer can serve as both an FP cavity and a dielectric gate for the electrostatic gating of a phase shifting medium. However, this device design may require the use of undesirably high voltages to gate the phase shifting medium and unnecessarily limit the achievable tuning range. Therefore, a separate dielectric gate material, such as a doped semiconductor, can be used to accomplish electrostatic gating with a significantly smaller voltage, allowing for a larger doping range and, therefore, larger angular emission tuning range.

The layers that make up the thermal laser may be in direct contact or may be separated by one or more layers of additional materials that protect the thermal laser layers from mechanical damage and/or chemical degradation, and/or that facilitate the fabrication of the device—provided that said additional layers do not interfere with the operation of the laser. For example, thin metal oxide layers, such as aluminum oxide (Al₂O₃) 114 and/or hafnium oxide (HfO₂) 116 can may be present above and/or below a layer of a phase shifting medium to provide mechanical support and/or to protect the phase shifting medium from contamination during processing.

The Fermi level or refractive index of phase shifting medium 108 determines the angle of emission lobe 119. Therefore, by modulating the Fermi level or refractive index of phase shifting medium 108, the emission angle can be changed. This modulation is strengthened by subwavelength dielectric gaps (g) between metal elements 107 which support gap plasmon modes and enhanced electric fields. (As used herein, the term “subwavelength” refers to wavelengths smaller than the wavelengths of emission.) These enhanced electric fields enhance the light-matter interaction between the FP cavity resonance mode and the phase shifting medium 108.

The operation of the thermal lasers is illustrated schematically in FIG. 1D. Heating dielectric spacer 102 enhances its thermal emission due to the oscillation of dipoles in the material. The thermal radiation couples with the oscillating Fabry-Perot resonance mode of the FP cavity and, upon interaction with nanoresonators 107, forms a gap plasmon that strongly couples the thermal radiation to phase-shifting medium 108. As a result, the metasurface transmits thermal radiation in an emission lobe centered at a given emission angle. The emission angle depends on the phase of reflection at metasurface 106, which can be modulated by modulating the Fermi level and/or refractive index of phase shifting medium 108.

In the case of an electronically tunable phase shifting medium, such as graphene, the emission angle of the lobe is controlled through electronic modulation of the carrier density and, therefore, the Fermi level, of the phase shifting medium that is incorporated into the metasurface. As the Fermi level is tuned by the application of an external voltage, the phase shift of the reflection at metasurface 106 is tuned. This changes the resonance condition of the FP cavity, selecting for resonant modes with a lateral component, and providing a tunable angle of emission for the laser. The angle dependence of the emissivity will depend on the particular materials used to construct the metasurface and the FP cavity. However, generally, the angular emission lobe will be centered around the normal direction for a given bias or temperature and will be shifted away from the normal direction by changing the bias voltage or temperature of the phase shifting medium.

The emission angle tuning can be explained in greater detail by starting from Kirchhoff's law, which states that altering the absorptivity of a thermal emitter by an engineered optical structure is equivalent to altering the emissivity to obtain the desired spatial and temporal thermal emission spectrum. Directional thermal absorption/emission can be obtained by the constructive interference between adjacent antenna elements in a device, which correspond to thermally excited dipoles in the thermal emitter. Thermal dipoles, however, are excited at random spatial and temporal positions, not well ordered as required for constructive interference. To obtain directional thermal emission, the dominant emission pathway should be a spatially delocalized resonant optical mode such that the only emitting thermal dipoles are coupled to and in phase with this resonant optical mode. All other dipoles will not emit radiation out the device, keeping the energy within the thermal emitter. In the thermal lasers disclosed herein, the spatially delocalized resonant optical mode is provided by the oscillating FP resonance in thick dielectric spacer 102 that is sandwiched between back reflector 104 and metasurface 106. The emission profile of the emitted angular lobe is modulated by shifting the phase of the reflection at the interface of the phase shifting medium, which modulates the resonance condition of the FP cavity.

Resonant emission for the FP mode occurs when the out-of-plane wavevector kₒᵤₜ, satisfies the constructive interference condition,

$$2 {k}_{out} h + {ϕ}_{m} + {ϕ}_{b} = 2 π * m \qquad ( 1 )$$

where ϕₘ and ϕ_{b} are the phase shifts of a propagating optical mode upon reflection at the metasurface and the back reflector, respectively, h is the thickness of the dielectric spacer, and m is an integer. In the infrared range, a metallic film back reflector acts as a perfect electric conductor, resulting in ϕ_{b}≈π. The momentum matching condition for free-space light can be derived from Snell's law as

$${k}_{out} = cos ( θ ) {nk}_{free} \qquad ( 2 )$$

where θ is the angle of emission, n is the index of the dielectric, and k_{free} is the free space wavevector. A larger free space momentum requires a larger θ to satisfy the momentum matching condition. ϕ_{b} and kₒᵤₜh are both independent of the phase shifting medium's Fermi level. In contrast, the reflection phase shift ϕₘ of the metasurface depends on the optical conductivity of the phase shifting medium.

In the thermal laser of FIGS. 1A-1C, metal elements 107 form a gap plasmon that strongly enhances the light matter interaction at the phase shifting medium interface, resulting in a deviation from a perfect metallic mirror reflection. As the Fermi level of the phase shifting medium is increased, the optical losses of the gap plasmon are increased, causing further deviation of the reflection phase from that of a perfect mirror, changing ϕₘ. Notably, the source of the reflection phase shift at the metasurface is not due to a plasmon in the phase shifting medium: rather, it is due to the strong interaction of the FP resonance mode at the phase shifting medium. Consequently, a change in ϕₘ results in a change in the angle of emission, θ, to maintain the constructive interference condition (Equation 1).

The operation of thermal lasers that use a thermally tunable phase shifting medium is similar to that of the thermal lasers that use an electronically tunable phase shifting medium. In the case of a thermally tunable phase shifting medium, the emission angle of the lobe is controlled through the thermal modulation of the refractive index of the phase shifting medium that is incorporated into the metasurface. As the refractive index is tuned by changing the temperature of the phase shifting medium, the phase shift of the reflection at metasurface 106 is tuned. This changes the resonance condition of the FP cavity and provides a tunable angle of emission for the laser.

In the Example below, a thermal laser having an adjustable emission angle is described using graphene as an illustrative phase shifting medium. The thermal laser of the Example was designed to maximize the signal tuning around 1500/cm, however the design principles of the thermal lasers described herein are not limited to this particular wavenumber and can be applied across the mid-infrared spectrum and beyond. This includes, but is not limited to, thermal lasers having emission wavelengths in the range from 3 μm to 40 μm. Similarly, while the thermal laser of the Example demonstrates a tunable emission angle of ±16° from normal, the thermal lasers are not limited to this particular angle range. Larger angle ranges, include ranges of ±20°, ±25°, ±30°, or larger can be achieved.

### EXAMPLE

This Example experimentally demonstrates the active control of angular thermal emission for a continuous range up to +/−16° at 1500 cm⁻¹, using the device of FIGS. 1A-1E.

### Device Fabrication

The device used in this Example included 30 nm thick, 1 micron-wide gold nanoresonators (metal elements) spaced 40 nm apart on top of a material stack that consists of 5 nm of HfO₂, a graphene sheet (the phase shifting medium), 30 nm of Al₂O₃, and a 2 micron-thick SiN membrane (the dielectric spacer) with a gold back reflector that also served as the back-gate electrode. A bilayer of 100 nm thick silicon oxides (SiOₓ) and 30 nm of gold was within the gap between the gold nanoresonators, a result of the negative tone resist used to pattern the structure via Electron Beam Lithography. The patterned area dimensions were 4 mm×4 mm and the membrane was supported on a 200 micron-thick Si frame. Electrical contact to the graphene was made by wire bonding to separated gold electrodes through the thin protective layer of HfO₂.

To measure the thermal emission of the active region, the sample (with electrical connections for gating) was placed on a heating stage with positioning and rotational control. The acceptance angle of the emitted light was 3° and because the signal was polarized along the gold nanoresonator, a polarizer was used.

### Tunable Emission Measurements on Thermal Emitter

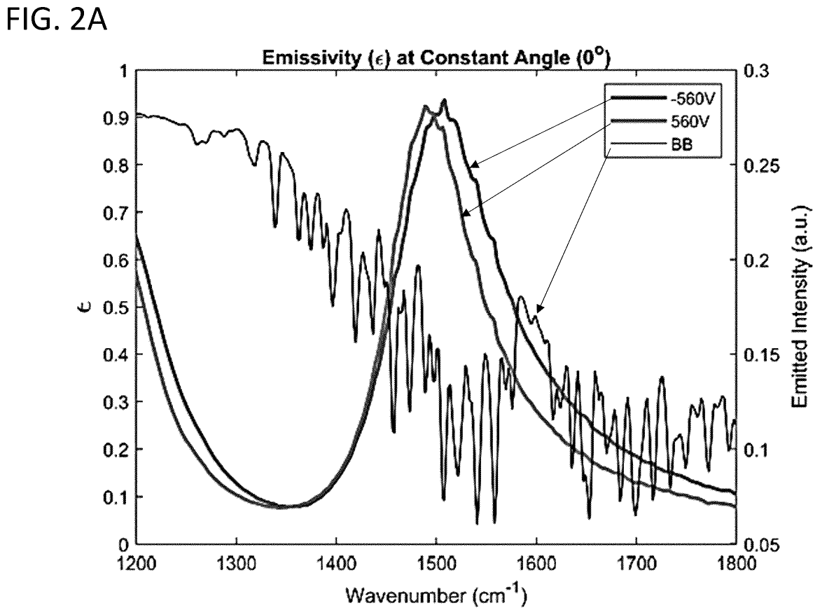

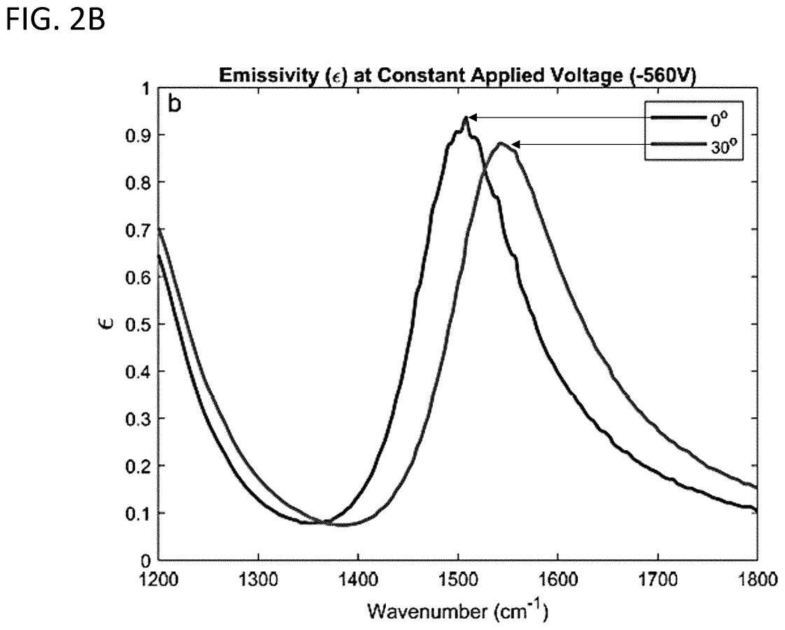

FIG. 2A (left axis) shows the emissivity at 250° C. of the device at normal incidence for two doped graphene Fermi levels, doped via a back-gate geometry (see FIG. 1A). The emissivity of the structure was calculated by normalizing the emitted radiation of the sample to the emitted radiation of a reference carbon nanotube blackbody (see right axis). By electrostatically tuning the graphene's Fermi level from 0.3 eV to 0.6 eV, the emission peak red-shifted from 1500 cm⁻¹ to 1450 cm⁻¹, indicating that the thermal emission peaks are broadly tunable with minor variation in the intensity.

To investigate the angle dependent features of these emission peaks, the sample was rotated and the change in emissivity was measured as a function of emission angle, as seen in FIG. 2B. These measurements are for a constant doping value and temperature. By increasing the emission measurement angle from 0° to 30°, a blue-shift was observed in the thermal radiation feature, confirming the structure's directional thermal emission. A minor reduction in the peak intensity at the larger angle (30°) was in part due to the measurement area elongating at larger angles to include some low emissivity, unpatterned gold areas, reducing the apparent emission peak magnitude.

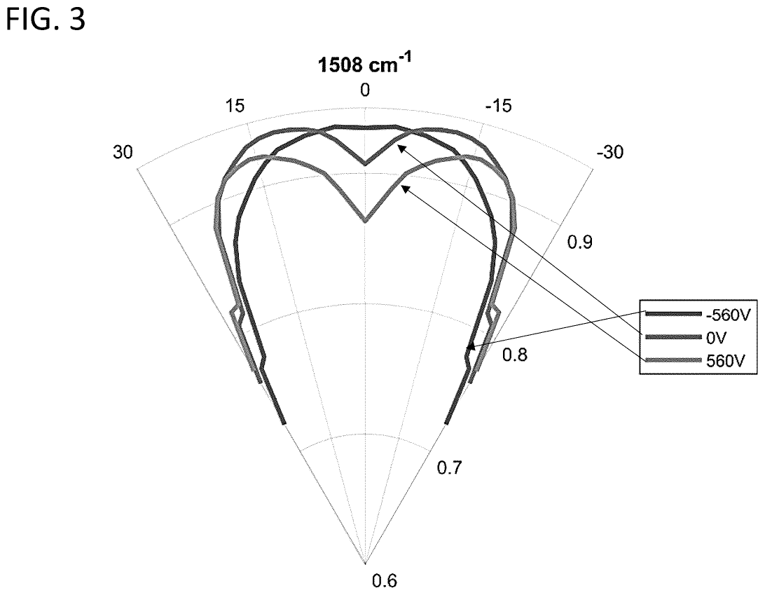

FIG. 3 plots the angle dependent emissivity of the hybrid graphene-gold metasurface as a function of doping value for a wavenumber of 1508⁻¹. The emission peaks form lobes ranging from 0° at high doping and 16° at low doping. For the doping value of 0.6 eV, it was observed that emission peak was most intense at normal incidence and decreased in intensity as the angle increased. As the Fermi level decreased, the lobe shifted from normal incidence to increasing angles, up to 16°, allowing for continuous tuning in that range.

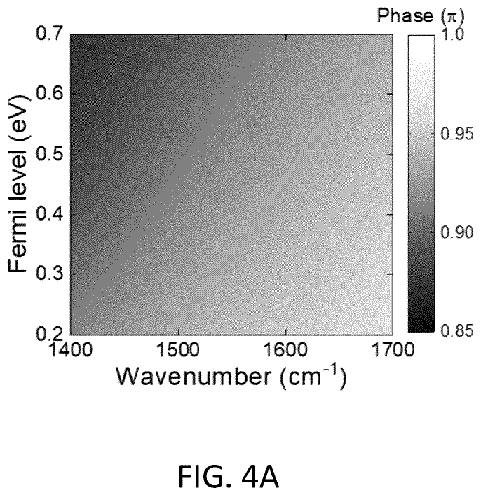

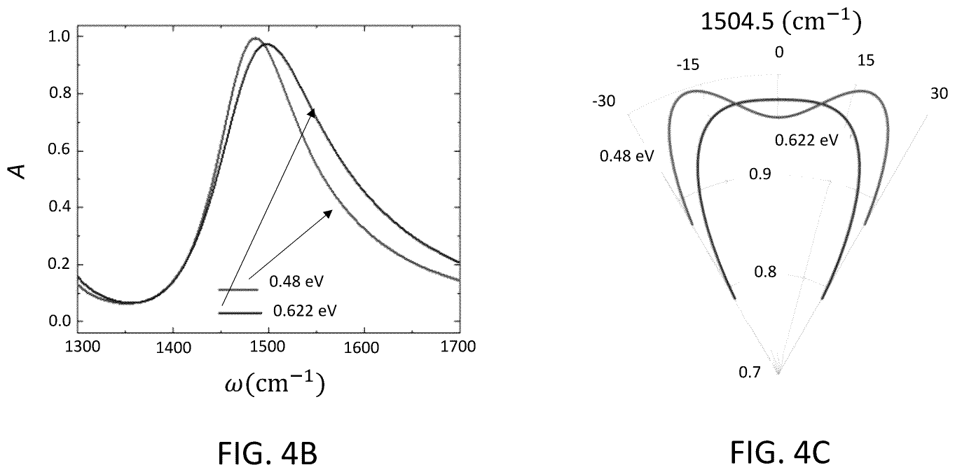

FIG. 4A shows the phase of reflection coefficient of the graphene-based metasurface for transverse magnetic polarized light as a function of the Fermi level. As the Fermi level is increased, the optical losses of the gap plasmon are increased, further deviating the reflection phase from that of a perfect mirror, changing ϕₘ. It is emphasized that the source of reflection phase shift is not due to a graphene plasmon, but is due to the strong interaction of the FP resonance at the graphene surface. Consequently, a change in ϕₘ changes the angle of emission, θ, to maintain the constructive interference condition, Equation 1.

FIGS. 4B and 4C show the calculated total absorption spectra for the device. The overall behavior is consistent with the experimental observations (see FIG. 3), although the emission lobes are broader and the tuning range of the emitter was less in the experimental device than was theoretically predicted. This inconsistency may be due to the metastructure geometric parameter variations across the full 4×4 mm² device and carrier density variation during the heating process.

The power of the thermal emitter can be calculated from Planck's law for the spectral radiance of a gray body. Using the measured emissivity (˜0.9) and bandwidth of constant angular tuning (4 cm⁻¹), the emitted power over the full 4 mm×4 mm area was calculated to be ≈0.14 mW. This emission power requires, allowing for convection and radiation loss, 200 mW to maintain the temperature of the device, leading to an extremely efficient MIR source.

### Materials and Methods

2 μm thick, 5 mm×5 mm SiN membranes on a 200 micron-thick Si frame were purchased from Norcada. Metal deposition of the back-reflector consisted of a 2.5 nm chromium adhesion layer and 100 nm of gold. Atomic Layer Deposition (a Fiji G2 ALD) was used to grow a 30 nm film of Al₂O₃ on the top of the SiN membrane. Once the Al₂O₃ was grown, a prepared graphene sheet was transferred on top of the Al₂O₃ film. Graphene was purchased from Grolltex and was grown on a Cu foil. To remove the foil, first a protective layer of PMMA (950k, A4, MicroChem Corp.) was added on top of the graphene. The Cu foil was etched away with FeCl3 (CE-100, Transene) then the graphene/PMMA stack was rinsed in a series of deionized water baths until transfer to the prepared membranes. Once transferred, the PMMA was removed by soaking in 60° C. acetone for 1 h. After the graphene transfer, a 5 nm film of HfO₂ was grown via atomic layer deposition. To prepare the SiN membranes for the next steps, the Si frame of the sample was glued to a carrier Si chip with PMMA (950 k, A8, MicroChem Corp.). The prepared substrate was then coated with a negative tone hydrogen silesquioxane resist (HSiQ, 6%, DisChem Inc.) at 100 nm. The sample was then exposed and patterned using the Elionix ELS G-100, an electron beam lithography tool. After exposure, the samples were developed in MF-321 for 90 s, with a 30 s rinse in DI water and then a 30 s rinse in IPA. For metal deposition of the top, a metal mask was placed above the substrate to create electrically disconnected regions. The deposition consisted of a 2.5 nm chromium adhesion layer and 30 nm of gold.

### FTIR Measurements

The emission measurements were performed using a Bruker Vertex 70 FTIR attached to a Hyperion 2000 microscope with a liquid-nitrogen-cooled mercury cadmium-telluride (MCT) detector with a potassium bromide (KBr) beam splitter. A carbon-nanontube source was used as the blackbody reference measurement.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” can mean only one or can mean “one or more.” Embodiments of the inventions consistent with either construction are covered.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A thermal laser comprising:
a back reflector;
a metasurface comprising:
a layer of a phase shifting medium having an electrically or thermally tunable Fermi level or index of refraction; and
a planar array of metal elements in a periodic arrangement on the layer of the phase shifting medium;
a dielectric spacer disposed between the back reflector and the metasurface; and
electrically conductive contacts configured to apply a voltage across the phase shifting medium or a phase shifting medium heater in thermal communication with the phase shifting medium; and
a dielectric spacer heater in thermal communication with the dielectric spacer.

2. The thermal laser of claim 1, comprising the electrically conductive contacts configured to apply a voltage across the phase shifting medium.

3. The thermal laser of claim 2, wherein the phase shifting medium is graphene.

4. The thermal laser of claim 3, wherein the planar array of metal elements is a planar array of parallel metal strips separated by subwavelength gaps.

5. The thermal laser of claim 4, wherein the metal strips are gold strips.

6. The thermal laser of claim 5, wherein the dielectric spacer is a silicon nitride spacer.

7. The thermal laser of claim 1, wherein the planar array of metal elements is a planar array of parallel metal strips separated by subwavelength gaps.

8. The thermal laser of claim 6, wherein the metal strips are gold strips.

9. The thermal laser of claim 1, wherein the phase shifting medium comprises indium tin oxide (ITO), indium zinc oxide (IZO), titanium nitride, vanadium dioxide (VO₂), germanium-antimony-tellurium (GST), titanium nitride, or an electro-optic polymer.

10. The thermal laser of claim 1, wherein the dielectric spacer is an aluminum oxide spacer or a diamond spacer.

11. The thermal laser of claim 1 comprising the phase shifting medium heater.

12. A method for creating a steerable thermal laser beam using the thermal laser of claim 1, the method comprising:
heating the dielectric spacer to generate thermal radiation, wherein said thermal radiation couples to an oscillating Fabry-Perot resonance mode in the dielectric spacer to generate a lobe of coherent radiation at an emission angle; and
either applying a voltage across the layer of the phase shifting medium or changing the temperature of the phase shifting medium, thereby changing the emission angle of the lobe of coherent radiation.

13. The method of claim 12, comprising applying the voltage across the layer of the phase shifting medium.

14. The method of claim 12, comprising changing the temperature of the phase shifting medium.

15. The method of claim 12, wherein the phase shifting medium is graphene.

16. The method of claim 15, wherein the planar array of metal elements is a planar array of parallel metal strips separated by subwavelength gaps.

17. The method of claim 16, wherein the metal strips are gold strips.

18. The method of claim 17, wherein the dielectric spacer is silicon nitride spacer.

19. The method of claim 12, wherein the planar array of metal elements is a planar array of parallel metal strips separated by subwavelength gaps.

20. The thermal laser of claim 12, wherein the phase shifting medium comprises graphene, indium tin oxide (ITO), indium zinc oxide (IZO), titanium nitride, and vanadium dioxide (VO₂), germanium-antimony-tellurium (GST), titanium nitride, or an electro-optic polymer and the dielectric spacer is a silicon nitride spacer. an aluminum oxide spacer. or a diamond spacer.
